(19) United States
(12) Patent Application Publication
(10) Pub. No.: US 2026/0153751 A1
(43) Pub. Date: Jun. 4, 2026

(54) ELECTRO-OPTICAL LENS AND FRAME INCLUDING SAME

(71) Applicant: WARBY PARKER INC., New York, NY (US)

(72) Inventors: RAVI JINDAL, New York, NY (US); DAVID J. DESHAZER, NEW YORK, NY (US); Bo ZHAO, New York, NY (US); Richard YEH, New York, NY (US)

(21) Appl. No.: 18/290,619

(22) PCT Filed: Nov. 27, 2023
(86) PCT No.: PCT/US2023/081068

§ 371 Date: Jan. 19, 2024

Related U.S. Application Data
(60) Provisional application No. 63/428,341, filed on Nov. 28, 2022.

(51) Int. Cl. G02C 7/10; G02C 1/00; G02C 7/02

(52) U.S. Cl. CPC G02C 7/101; G02C 1/10; G02C 7/022; G02C 2202/16

(57) ABSTRACT

A lens includes an electro-optical device including an active zone and an inactive zone; and an ophthalmic lens bonded to the electro-optical device, wherein a perimeter of the ophthalmic lens is substantially aligned with a perimeter of the active zone.

### CROSS REFERENCE TO RELATED APPLICATION

This application claims the benefit of U.S. Provisional Patent Application No. 63/428,341, filed Nov. 28, 2022, which is hereby incorporated by reference for all purposes as if fully set forth herein.

### BACKGROUND

The present disclosure relates to eyewear. More specifically, the present disclosure relates to an electro-optical lens eyeglass and a frame with an electro-optical lens.

### SUMMARY OF THE DISCLOSURE

Embodiments of the present disclosure include an ophthalmic lens including an electro-optical device, an eyeglass frame including a lens that includes an electro-optical device, and method of mounting a lens that includes an electro-optical device in an eyeglass frame.

In an embodiment, a lens includes an electro-optical device including an active zone and an inactive zone; and an ophthalmic lens bonded to the electro-optical device, wherein a perimeter of the ophthalmic lens is substantially aligned with a perimeter of the active zone.

In an aspect, the electro-optical device is electrochromic.

In an aspect, the ophthalmic lens includes a first ophthalmic lens and a second ophthalmic lens, and the first ophthalmic lens is bonded to a first surface of the electro-optical device and the second ophthalmic lens is bonded to a second surface of the electro-optical device.

In an aspect, the electro-optical device further includes a protrusion extending from the inactive zone.

In an aspect, the protrusion includes a connection to an electrode of the electro-optical device.

In an aspect, the electro-optical device is configured to be switched between a clear state and a dark state.

In an aspect, the no-tint control zone is around a perimeter of the lens outside of the active zone.

In an aspect, the electro-optical device is larger than the ophthalmic lens.

In an aspect, the electro-optical device and the ophthalmic lens are curved.

In an embodiment, an eyeglass includes an electro-optical lens including an active zone and an inactive zone around a perimeter of the electro-optical lens; and a plurality of frame components including an outer frame component and an inner frame component, at least one of the outer frame component and the inner frame component including a recess configured to fit the inactive zone of the electro-optical lens such that the outer frame component and the inner frame component are joined flush together around the electro-optical lens.

In an aspect, the outer frame component and the inner frame component are curved.

The electro-optical device can further include a user control that is configured to control a voltage to the electro-optical lens.

In an aspect, the electro-optical lens includes an ophthalmic lens bonded to an electro-optical device.

In an aspect, the electro-optical device is electrochromic.

In an aspect, the electro-optical lens is a prescription lens.

In an aspect, the electro-optical device is configured to be switched between a clear state and a dark state.

In an aspect, a portion of the inactive zone protrudes from the electro-optical lens.

In an aspect, the portion of the inactive zone that protrudes from the electro-optical lens incudes a connection to an electrode of the electro-optical lens.

In an aspect, a perimeter of the ophthalmic lens is substantially aligned with a perimeter of the active zone.

In an aspect, the electro-optical device is larger than the ophthalmic lens.

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

FIG. 1 and FIG. 2 show examples of an electro-optical device in accordance with some embodiments.

FIG. 3 shows examples of a lens including an electro-optical device in accordance with some embodiments.

FIG. 4 and FIG. 5 show an example of a curved lens including an electro-optical device in accordance with some embodiments.

FIG. 6 shows an example of a lens in an eyeglass frame in accordance with some embodiments.

FIG. 7 and FIG. 8 show an example of a lens mounted in an eyeglass frame in accordance with some embodiments.

FIG. 9 and FIG. 10 show an example of an eyeglass frame in accordance with some embodiments.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Disclosed is an eyeglass (or eyeglasses) in which a lens can include an embedded electro-optical device. The electro-optical device changes optical properties of an optically active material in response to an electric field or current. Electro-optical devices include waveguides, liquid crystal displays, microLEDs, organic light-emitting display (OLED) and other emissive displays, light valves, and electrochromic devices. Such optically active materials include liquid crystals and electrochromic materials. Electrically modulating an optically active material with an electric field can change the birefringence, polarization, index of refraction, transmission/opacity, color/tint, and clarity/haze of an electro-optical device having the optically active material.

The eyeglasses can include a frame and prescription lenses including the electro-optical device. The included electro-optical device can permit the wearer to switch electronically between a first state, which may be a clear state, and a second state, which may be a dark state, using an electrochromic effect. This situation is similar to that of a traditional pair of eyeglasses (in a first or clear state) and a typical pair of sunglasses (in a second or dark state). It should be understood that while two states are referenced, additional states may be possible. For example, a third or fourth state may permit various degrees of darkening between the clear state and the dark state. The disclosed frames with lenses including an electro-optical device may be capable of all-day wear and are different from existing eyeglasses with transitional lenses by providing sufficient transmission in the clear state to be worn in low-light (dark) environments. The combination of an electro-optical device, prescription lenses, and electronic-equipped frame has driven the creation of new lens manufacturing and insertion techniques.

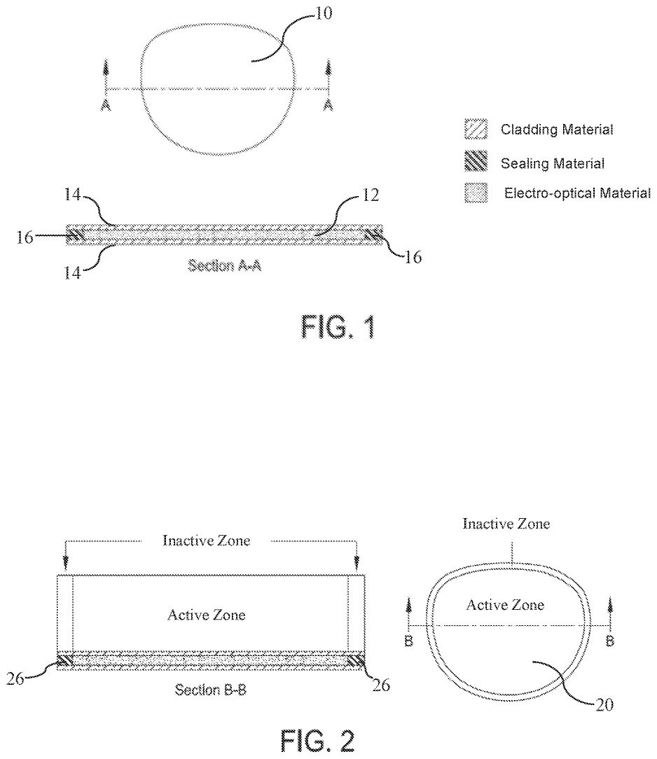

FIG. 1 shows an electro-optical device 10, for example an electrochromic device. As shown, the electro-optical device 10 can be defined in a shape of an eyeglass lens. The electro-optical device 10 can include an electro-optical material 12 sandwiched between two substrates or cladding material 14. For example, the electro-optical material 12 can be an electrochromic gel. The cladding material 14 can be glass as the outermost layers of the electro-optical device 10 to provide an oxygen barrier for the electro-optical material 12. In some embodiments, the cladding material 14 can be plastic, laminate, or any other suitable material. The cladding material 14 also provides a structural base in which to attach other lens components and for mechanically mounting lenses to an eyeglass frame. The interior cladding material surfaces can be coated with a transparent electrode material. For example, the electrode can be indium tin oxide (ITO) or other suitable material. The circumferential edge of the electro-optical device 10 can be sealed with a sealing material 16 to join the cladding materials 14 together and protect the electro-optical material 12.

Although not shown, a power source, such as a battery, can be connected to electrodes of the electro-optical device 10. The power source can be used to provide a voltage potential across the two electrodes. An optical property of electro-optical material between the two electrodes can be changed or controlled by varying the voltage potential and/or electrical current across the electrodes.

In some embodiments, the region of the electro-optical device including the electrochromic material can be controlled to change the optical property. For example, in the lens 20 illustrated in FIG. 2, a portion inside the sealing material 26 can be an active zone and an outer perimeter of the lens 20 can have a portion that is not controllable, e.g., an inactive zone. That portion is around the perimeter of the lens 20 where there is no electro-optical material but instead includes the sealing material 26. It should be understood that the active zone can extend to the entire outer perimeter of the lens 20 in some embodiments.

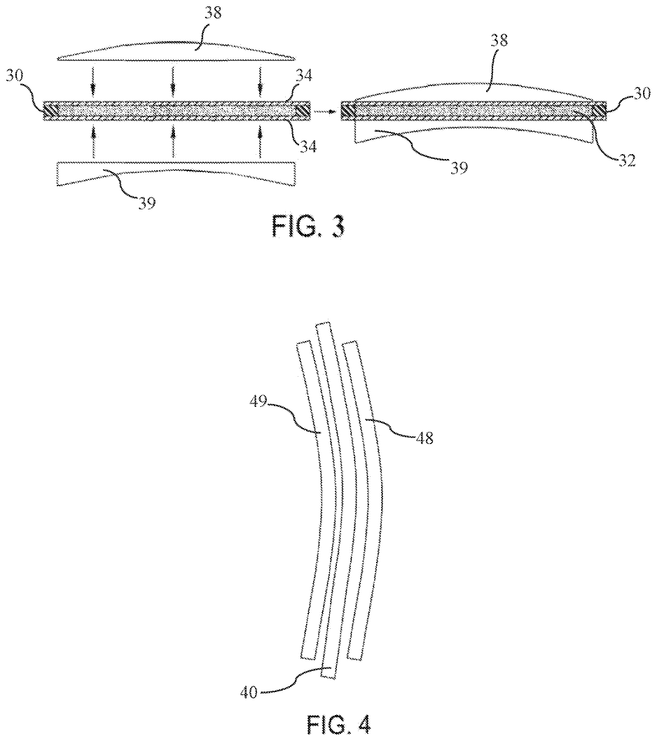

FIG. 3 shows an example of an electro-optical device 30 that can be included as a portion of an ophthalmic lens. In an embodiment, the electro-optical device 30 can be an electrochromic device. For example, FIG. 3 shows that two lens halves 38, 39 (or portions) can be optically bonded or laminated to outer surfaces of the substrates 34 with one lens half (or one portion) on each substrate 34. In some embodiments, only one of the substrates 34 can be bonded to an ophthalmic lens. As shown, the ophthalmic lens portions 38, 39 can be smaller than the electro-optical device 30 to which they are attached. The perimeter of the ophthalmic lens portions 38, 39 can be substantially aligned with a perimeter of the electro-optical material 32, with ‘substantially’ being within manufacturing tolerances. This arrangement produces a lens that does not require edging after final assembly and also creates a new opportunity for assembly/mounting. Lamination or bonding, such as by using optical-grade adhesives, can be used to combine the layers 30, 38, and 39.

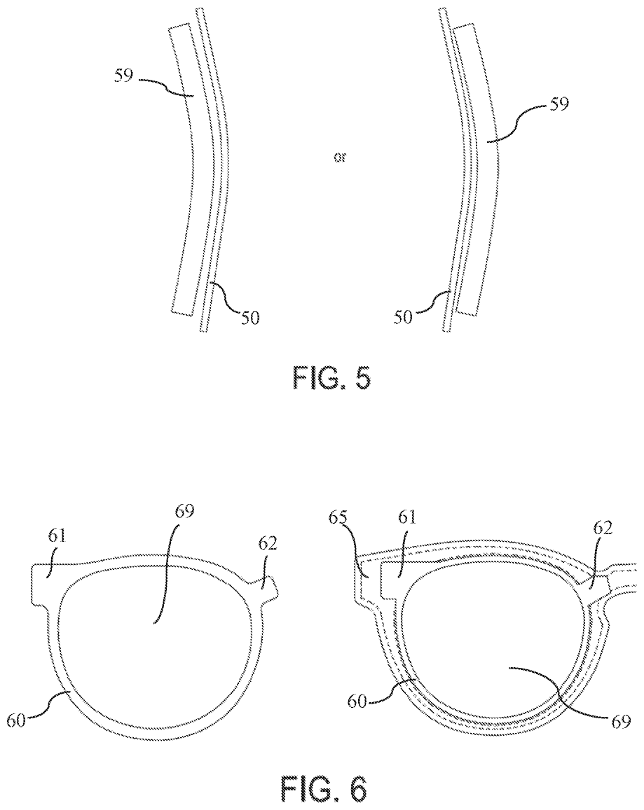

Although FIG. 3 shows a lens created with an electro-optical device 30, it should be understood that the electro-optical device 30 can be an electrochromic device, a waveguide, an electronic display, a light valve, and the like. Although FIGS. 1-3 show that the electro-optical device is flat, it should be understood that the electro-optical device can be curved, as shown in FIGS. 4 and 5.

FIGS. 4 and 5 show that an ophthalmic lens can also be curved to match or mate with a curve of an electro-optical device (i.e., an embedded film). For example, FIG. 4 shows that the curve of the electro-optical device 40 matches two halves of a curved ophthalmic lens, a curved front ophthalmic lens 48 and a curved rear ophthalmic lens 49. FIG. 5 shows that an oversized (e.g., larger) electro-optical device 50 can be laminated to one surface, either a front surface or a rear surface, of a meniscus lens 59. However, the electro-optical device 50 need not mimic the shape of the ophthalmic lens.

For example, FIG. 6 shows an ophthalmic lens 69 that includes protrusions 61, 62 in the electro-optical device 60 (i.e., electrochromic film). Such protrusions 61, 62 can be used for mounting/handling purposes and provide access points for electrical connections to the electrodes on the substrates of the electro-optical device 60. One of the protrusions 61, 62 can be connected to one electrode on one substrate of the electro-optical device 60 and the other of the protrusions 61, 62 can be connected to the other electrode on the other substrate of the electro-optical device 60. FIG. 6 also shows how the ophthalmic lens 69 with protrusions 61, 62 defined in the electro-optical device 60 can be mounted within an eyeglass frame 65 such that the protrusions 61, 62 can be buried or hidden within an outline of the frame 65.

It should be understood that instead of laminating an ophthalmic lens to an electro-optical device, an ophthalmic lens can be co-molded, 3D printed, or produced in another way directly onto the electro-optical device. This method can permit creation of an overall thinner lens.

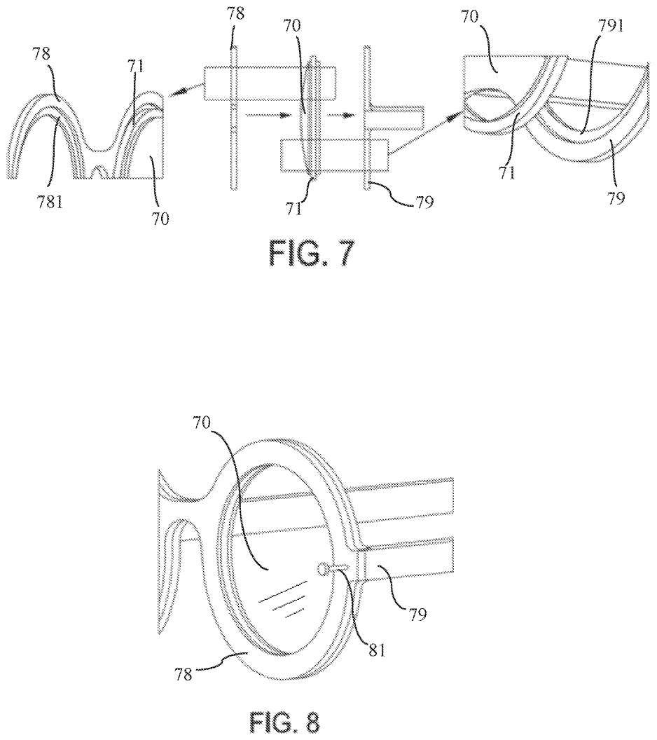

FIGS. 7 and 8 show how an ophthalmic lens 70 including an electro-optical device can be mounted in an eyeglass frame 78/79. For example, the eyeglass frame 78/79 can be defined as including at least two pieces 78 and 79. FIG. 7 shows that at least one of the outer frame piece 78 and the inner frame piece 79 can include a groove, cavity, or recess 781 and 791, respectively, sized and configured to accommodate a protrusion of the electro-optical device 71 that is around the perimeter of the lens 70. As shown, portions of frame pieces 78, 79 can include respective cavities or recesses 781, 791 that surrounds the lens edge and therefore allows the two frame pieces 78, 79 to be arranged as flush against each other, as seen in FIG. 8. The benefit of this approach is that there is no need for edging the lens to 70 ensure the lens 70 fits in the frame 78/79. Additionally, there is no risk of damaging internal components or interconnections of the electro-optical device by snapping a lens into a frame. Additionally, a least one portion of the frame 78/79 can include a channel or groove used to route wiring to the electrodes of the electrochromic device.

FIG. 8 shows that the two frame pieces 78, 79 can be secured flush together with the lens 70 in between the two pieces 78, 79. Because the lens 70 is placed within a recess of one or both of the frame pieces 78, 79, the frame pieces 78, 79 can be joined with no gap in between. The frame pieces 78, 79 can be joined using a press fit, a fastener, such as a screw or rivet 81, an adhesive, or by any suitable technique. Although shown as being flat, the frame pieces 78 and 79 can curved.

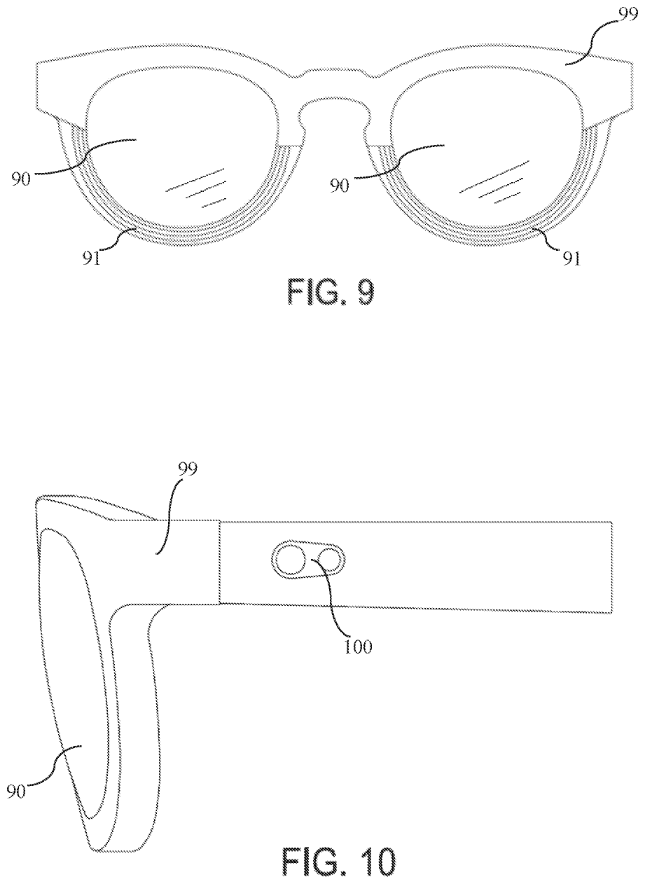

FIGS. 9 and 10 are views illustrating an eyeglass frame 99 including an ophthalmic lens 90 with an electro-optical device according to an embodiment of the present disclosure. FIG. 9 is a front view of the eyeglass frame 99 with a portion of the frame 99 cut away so that a perimeter portion of the lens 90 is visible. The protrusion 91 of the electro-optical device is shown as the outermost perimeter feature.

FIG. 10 is a side view of the eyeglass frame 99 showing that a user control 100 can be located on a temple. For example, the user control 100 can be a physical control, such as a switch, potentiometer, slider, dial, knob, rotary control, touch control (e.g., capacitive or resistive sensor), or any other suitable device that permits a user to control the voltage or power to the electro-optical device included in the lens 90 using physical contact. Although not shown, a power source, such as a battery to power the electro-optical device, can be provided within the frame 99 and operated via the user control 100.

In an aspect, a user control can be omitted from the eyeglass frame and the electro-optical device can be controlled via a short-range wireless technology (e.g., Bluetooth, Near-Field Communication (NFC), to list only a couple of examples). For example, the electro-optical device can be controlled using a software application running on a mobile device, such as a smartphone or tablet, or on a computer. In an aspect, the electro-optical device can be controlled based on output from an ambient light sensor mounted to the frame. In an aspect, the electro-optical device can be controlled based on output from a sensor (e.g., an image sensor) detecting changes or size of a wearer's pupil.

For example, in an embodiment, the image sensor can be aimed to capture the size of a user's pupil and images captured can be analyzed to determine when a size (e.g., diameter or circumference) of the user's pupil changes over a period of time. In another example, the images obtained from the image sensor can be analyzed to identify a size of the user's pupil. The determined size can be compared to a reference value, which may be a predetermined average pupil size (e.g., nominally 12 mm) or a predetermined pupil size for the particular user. In some embodiments, the predetermined pupil size for the user can be obtained and configured during an initial setup period in one or more light conditions as will be understood by one of ordinary skill in the art.

For example, in an embodiment, an image sensor can be aimed to capture vergence of the user's pupils and tracked in real time to determine if the user is looking near or far. This information can be used to control the electro-optical device and/or control power of a prescriptive ophthalmic lens.

In another example, the user control can include a microphone in communication with a processor that is configured to recognize one or more sounds. For example, a user's voice can control the electro-optical device. In another example, a camera or other image sensor(s) can be supported by the frame and be configured to image a pupil of the user (wearer). Image processing can be performed on the obtained images to determine a size of the pupil and control the electro-optical device based on the pupil size, which may be correlated to an ambient light level. Examples of algorithms that may be used to determine pupil size are disclosed in U.S. Provisional Patent Application No. 63/426,929, filed Nov. 21, 2022 and in U.S. Patent Application Publication No. 2021/0393121, entitled “System and Method for Measuring Pupillary Distances and Uses Thereof,” which references are incorporated by reference herein in their entireties.

In some embodiments, multiple images can be acquired using the camera or image sensor(s) and the processor and can be configured to detect when a user blinks, and blinking in a certain pattern or at a certain frequency can be detected and used to control the electro-optical device. In some embodiments, the processor can be configured to process one or more images to detect when the user is squinting (e.g., a distance between an upper and lower lid decreases) and can control the electro-optical device, such as by causing the electrochromic material to darken. One of ordinary skill in the art will understand that other suitable methods of controlling an electro-optical device using sound, touch, and/or vision or imaging can be implemented.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A lens, comprising:
an electro-optical device including an active control zone and an inactive zone; and
an ophthalmic lens bonded to the electro-optical device, wherein a perimeter of the ophthalmic lens is substantially aligned with a perimeter of the active zone.

2. The lens of claim 1, wherein the electro-optical device is electrochromic.

3. The lens of claim 1, wherein
the ophthalmic lens includes a first ophthalmic lens and a second ophthalmic lens, and
the first ophthalmic lens is bonded to a first surface of the electro-optical device and the second ophthalmic lens is bonded to a second surface of the electro-optical device.

4. The lens of claim 1, wherein the electro-optical device further includes a protrusion extending from the inactive zone.

5. The lens of claim 4, wherein the protrusion includes a connection to an electrode of the electro-optical device.

6. The lens of claim 1, wherein the electro-optical device is configured to be switched between a clear state and a dark state.

7. The lens of claim 1, wherein the inactive zone is around a perimeter of the lens outside of the active zone.

8. The lens of claim 1, wherein the electro-optical device is larger than the ophthalmic lens.

9. The lens of claim 1, wherein the electro-optical device and the ophthalmic lens are curved.

10. An eyeglass comprising:
an electro-optical lens including an active zone and an inactive zone around a perimeter of the electro-optical lens; and
a plurality of frame components including an outer frame component and an inner frame component, at least one of the outer frame component and the inner frame component including a recess configured to fit the inactive zone of the electro-optical lens such that the outer frame component and the inner frame component are joined flush together around the electro-optical lens.

11. The eyeglass of claim 10, wherein the outer frame component and the inner frame component are curved.

12. The eyeglass of claim 10, further comprising a user control that controls a voltage to the electro-optical lens.

13. The eyeglass of claim 10, wherein the electro-optical lens includes an ophthalmic lens bonded to an electro-optical device.

14. The eyeglass of claim 10, wherein the electro-optical device is electrochromic.

15. The eyeglass of claim 10, wherein the electro-optical lens is a prescription lens.

16. The eyeglass of claim 10, wherein the electro-optical device is configured to be switched between a clear state and a dark state.

17. The eyeglass of claim 10, wherein a portion of the inactive zone protrudes from the electro-optical lens.

18. The eyeglass of claim 17, wherein the portion of the inactive zone that protrudes from the electro-optical lens incudes a connection to an electrode of the electro-optical lens.

19. The eyeglass of claim 13, wherein a perimeter of the ophthalmic lens is substantially aligned with a perimeter of the active zone.

20. The eyeglass of claim 13, wherein the electro-optical device is larger than the ophthalmic lens.
